(19) United States
(12) Patent Application Publication
(10) Pub. No.: US 2025/0095507 A1
(43) Pub. Date: Mar. 20, 2025

(54) VOCABULARY ASSESSMENT SYSTEM

(71) Applicant: Joanna B. Stegall, Anderson, SC (US)

(72) Inventor: Joanna B. Stegall, Anderson, SC (US)

(21) Appl. No.: 18/888,699

(22) Filed: Sep. 18, 2024

Related U.S. Application Data
(60) Provisional application No. 63/583,378, filed on Sep. 18, 2023.

(51) Int. Cl. G09B 7/12; G06F 16/28

(52) U.S. Cl. CPC G09B 7/12; G06F 16/285

(57) ABSTRACT

The present disclosure describes a system and method for conducting continuous vocabulary matching assessments, distinguished by its dynamic, metadata-driven taxonomy that seamlessly adapts to diverse educational curricula. The system manages vocabulary associated with one or more courses and receives input from learners regarding vocabulary words and their corresponding definitions. The system dynamically generates assessment probes, enabling ongoing tracking of student progress and comprehension throughout the course. The system integrates a ChatBot offering real-time feedback and personalized instructional content to learners and collaborates with instructors. The ChatBot provides insights, recommendations, and strategic interventions based on continuous analysis of student performance, setting this system apart from traditional tools that lack such adaptive, interactive capabilities. By utilizing a dynamic taxonomy and real-time interactions, the system ensures that assessments are both relevant and responsive to the evolving educational context, supporting the acquisition and retention of essential vocabulary across a wide range of subjects.

### CROSS-REFERENCE TO RELATED APPLICATION

This application claims the benefit of priority of U.S. provisional application No. 63/583,378, filed Sep. 18, 2023, the contents of which are herein incorporated by reference.

### BACKGROUND OF THE INVENTION

### Field of the Invention

The present invention pertains to an advanced educational formative vocabulary assessment system designed for application across a broad spectrum of educational levels and subject areas, from grade schools to post-secondary institutions. This system introduces a novel method of administering brief, yet comprehensive, weekly vocabulary matching assessments, each limited to five minutes or other predetermined time intervals, ensuring that these evaluations are both time-efficient and effective in measuring student progress. The universality of this system lies in its capability to be seamlessly applied across a wide array of subjects, educational contexts, and grade levels, utilizing a consistent and scalable curriculum-based measurement model. Unlike traditional assessment tools that are often limited to specific subjects or grade levels, this invention employs a dynamic, metadata-driven taxonomy that can be customized to align vocabulary terms with diverse educational objectives and curriculum standards. This adaptability allows for personalized assessments that are directly relevant to the unique instructional content of each classroom, while still maintaining a uniform method for tracking and evaluating student growth across the length of the course and with different subjects and educational levels.

A significant novelty of this system is its integration of advanced technologies, including a Retrieval Augmented Generation (RAG) chatbot that functions as a proactive personal learning assistant. This chatbot is designed to dynamically analyze real-time student performance data and engage students in personalized dialogues, delivering instructional content that is contextually relevant and tailored to address specific areas of weakness. For educators, the chatbot provides actionable insights and recommendations, enabling them to make data-driven instructional adjustments that are responsive to the latest student performance data. This dual functionality-supporting both students and teachers-sets the system apart from traditional assessment methods, which typically lack the capability to offer continuous, real-time feedback and personalized learning experiences. By offering a single, universally applicable framework for student progress monitoring and assessment, this system simplifies implementation, training, and usage, making it an invaluable tool across a wide range of educational settings. This level of flexibility, combined with the ability to provide continuous, real-time insights, represents a significant advancement over existing point-in-time assessments, which often fail to capture the ongoing development of student knowledge and skills.

### Description of the Related Art

Conventional student assessment systems in the general education market primarily focus on evaluating content mastery within specific, discrete topics, such as a unit, chapter, or subject area. These systems generally assess a student's understanding at a single point in time, providing insights into their proficiency in the skills being taught at that moment. While such assessments may offer a snapshot of a student's capabilities, they are inherently limited in scope, failing to provide a comprehensive view of a student's educational growth and development over the entirety of a course. Consequently, these traditional assessments offer limited utility in instructional planning and often require substantial time to administer, thus detracting from valuable instructional time.

Furthermore, traditional assessment systems typically employ summative assessments, which are administered at the conclusion of an instructional period, such as a unit, semester, or academic year. Although these summative assessments can measure whether a student has achieved a certain level of content mastery, they do not effectively track the student's progress or the retention of skills throughout the course. The reliance on point-in-time evaluations means that struggling students may not be identified until their performance has significantly deteriorated, making it increasingly difficult to provide timely and effective interventions. In such scenarios, instructors lack the continuous data needed to make informed instructional decisions or to offer targeted supplemental instruction that could address emerging learning deficits.

In addition, traditional assessment systems are often characterized by a lack of flexibility and scalability, as they are typically designed to evaluate specific subjects or grade levels. This design limitation presents significant challenges when attempting to apply such systems across a broader range of educational contexts, leading to inconsistencies in progress tracking. As a result, educators are frequently compelled to utilize different assessment tools and methodologies for varying subjects and grade levels, which complicates the overall assessment process and can lead to fragmented and incomplete evaluations of student progress.

Therefore, there exists a need for a more effective, time-efficient, and versatile assessment system that can continuously monitor student progress and provide both instructors and students with real-time insights into educational growth over the duration of a course. Such a system would address the shortcomings of traditional assessments by offering a more holistic evaluation of student development, supporting the dynamic adjustment of instructional strategies based on ongoing, data-driven insights. This would represent a substantial improvement over existing assessment tools, enabling more consistent, scalable, and comprehensive monitoring of student progress across a wide range of subjects and educational levels.

### SUMMARY OF THE INVENTION

The following presents a simplified summary of the present disclosure in a simplified form as a prelude to the more detailed description that is presented herein.

In accordance with embodiments of the present invention, there is provided a method for performing vocabulary matching measure assessments, designed to enhance content mastery across a broad spectrum of educational courses. The method includes receiving, by a vocabulary assessment system, vocabularies associated with one or more courses. The system further receives inputs from a learner corresponding to one or more words and their associated definitions. The method also encompasses receiving a command from the learner to submit a probe, followed by outputting the probe results based on the input words and definitions.

The system and method described herein offer a significant advancement over traditional educational assessment tools by providing real-time data on student growth, thereby facilitating timely and effective educational interventions. Unlike conventional systems, which often rely on point-in-time assessments, the present invention introduces a consistent and universal model that can be applied across a wide array or matrix of subjects and educational levels, from K-12 to post-secondary education. The system employs a novel approach to vocabulary matching as a form of curriculum-based measurement, enabling continuous monitoring of student progress throughout the duration of a course, rather than merely assessing content mastery at isolated intervals.

A distinctive feature of this invention is its dynamic, metadata-driven taxonomy, which allows for the personalization of vocabulary assessments in direct alignment with classroom-specific educational objectives. This ensures that the system remains adaptable to various curricular demands while maintaining a uniform method for tracking and evaluating student growth. Furthermore, the system integrates a Retrieval Augmented Generation (RAG) chatbot that acts as a proactive personal learning assistant for both students and educators. This chatbot analyzes real-time assessment data, engages students in personalized learning dialogues, and provides educators with actionable insights and recommendations, thereby enabling data-driven instructional adjustments that can be dynamically adapted to meet the evolving needs of students.

The universal applicability of this system, combined with its ability to provide continuous, real-time feedback, represents a novel and non-obvious improvement over existing educational technologies. Currently, no other online tool, as researched through prior art, can conduct brief, frequent, and comprehensive curriculum-based monitoring of essential vocabulary across such a diverse range of subjects and educational levels. This invention not only addresses the limitations of traditional assessment systems but also introduces a scalable, adaptable, and universally applicable solution that supports more effective and timely educational interventions.

In one aspect of the present invention, a method for performing vocabulary matching measure assessment to enhance content mastery in a course curriculum, includes the following: administering a vocabulary assessment module configured to randomly select a plurality of content-specific vocabulary terms and a plurality of definitions (including two distractors) from across the entire course curriculum, limit each assessment to an institutionally determined duration to ensure consistent and frequent evaluation, and assess both immediate comprehension and long-term retention of vocabulary across the breadth of the course curriculum through consistent weekly probes, providing continuous data that reflects student progress over time; establishing a baseline performance for each student at the beginning of the course and generating a trendline based on near real-time data from weekly assessments, wherein the trendline is continuously updated to: monitor student progress, identify potential at-risk students early, predict overall student course outcomes with statistical reliability and validity, and provide insights into whether the student is making adequate progress relative to predefined educational benchmarks; utilizing a dynamic metadata-driven taxonomy to: align each vocabulary term with specific course content, educational objectives, and curriculum standards, and personalize assessments based on the unique instructional content of each classroom while maintaining a uniform method for tracking and evaluating student growth across diverse subjects and educational levels, thereby enabling consistent and comparable growth monitoring across the entire student population; analyzing student probe results through a Retrieval Augmented Generation (RAG) chatbot module, wherein the chatbot module is provided with a customizable corpus of supplemental instructional content and configured to: identify areas of weakness based on near real-time analysis of the student's performance in the weekly assessments, proactively engage the student in personalized dialog by delivering contextually relevant instructional content that is dynamically adapted to address identified weaknesses, ensuring that the learning interventions evolve based on the student's most current needs, act as a continuous, adaptive learning assistant that adjusts its instructional strategies in near real-time based on the student's ongoing progress and interaction history, promoting sustained engagement and improved learning outcomes; outputting results of each assessment probe to both the student and instructor, wherein the system provides: actionable insights into student performance across the entirety of the course curriculum, enabling educators to quickly identify at-risk students and implement timely interventions, continuous growth monitoring that offers near real-time feedback on student progress, allowing educators to adapt their teaching strategies and provide targeted support based on the latest data, comparative analytics that align individual student progress with broader educational standards and objectives, ensuring that both students and educators receive data-driven feedback that is continuously updated and contextually relevant, recommendations for instructional adjustments or targeted interventions based on the latest assessment data, enabling educators to refine their teaching strategies in response to near real-time insights into classroom performance, predictive analytics that forecast overall student course outcomes with statistical reliability and validity, providing educators with advanced insights into potential student success or failure, thereby enabling proactive, data-driven instructional planning and intervention.

In another aspect of the present invention, the foregoing method further includes wherein the Retrieval Augmented Generation (RAG) chatbot module is further configured to: automatically update the customizable corpus of supplemental instructional content by incorporating new educational resources, instructional materials, and student performance data in real-time; refine the selection and delivery of content during student interactions based on patterns of student engagement, comprehension levels, and areas of repeated difficulty; adjust its instructional strategies dynamically to address emerging trends in student performance, thereby enhancing the precision and relevance of the content provided for reinforcing content mastery and addressing knowledge gaps, wherein the instructor insights module is further configured to: generate detailed reports that correlate student performance on vocabulary assessments with broader content mastery outcomes across the curriculum; identify specific content areas within the curriculum where a majority of students are experiencing difficulty, and recommend targeted instructional strategies, such as re-teaching sessions, differentiated instruction techniques, or supplemental learning resources; provide predictive analytics that forecast potential future areas of difficulty based on historical student performance data, enabling preemptive instructional adjustments to mitigate learning challenges before they impact overall student success, wherein the assessment module is further configured to: track and analyze longitudinal student performance data to identify trends in knowledge retention and application over time, including the ability to recall and apply previously learned vocabulary in new contexts; provide real-time feedback to students promptly after each assessment, offering immediate reinforcement or correction based on their responses, thereby enhancing the learning experience by reinforcing correct usage and understanding of vocabulary terms as they relate to broader content mastery; administer consistent weekly vocabulary assessment probes, each designed to be brief yet comprehensive, leveraging a randomized selection of vocabulary terms that span the entire course curriculum, thereby enabling a continuous, broad-spectrum evaluation of student content mastery, retention, and areas requiring further intervention, wherein the Retrieval Augmented Generation (RAG) chatbot module is further configured to: analyze student interactions during vocabulary assessment probes to identify patterns of misunderstanding or frequent errors, and dynamically adjust its dialog and instructional strategies to address these specific issues in subsequent engagements; initiate proactive “nudges” based on identified areas of weakness, offering tailored supplemental content and exercises directly related to the student's performance on the weekly vocabulary probes; provide a personalized learning experience by continuously adapting its engagement style and instructional content to align with the student's evolving understanding and content mastery throughout the course curriculum, wherein the instructor insights module is further configured to: aggregate data from individual student interactions with the Retrieval Augmented Generation (RAG) chatbot and the weekly vocabulary probes to generate comprehensive classroom-level analytics; identify and visualize trends in student performance across the curriculum, highlighting common areas of difficulty and potential knowledge gaps that may require re-teaching or enhanced instructional strategies; offer actionable recommendations for instructional adjustments, such as modifying lesson plans, introducing targeted group activities, or integrating additional supplemental resources, based on the collective analysis of student performance data, wherein the Retrieval Augmented Generation (RAG) chatbot module is further configured to: integrate with external data sources, such as educational databases and online resources, to continuously update and expand its corpus of supplemental instructional content, ensuring that the chatbot remains aligned with the latest educational standards, research, and best practices, thereby offering students and educators access to up-to-date and contextually relevant learning materials, a feature that contrasts with the static content repositories typical of traditional educational systems; dynamically adjust its instructional strategies based on real-time analysis of student performance data, including their interaction patterns and comprehension levels during chatbot engagements, enabling the delivery of highly personalized and adaptive learning experiences that evolve with the student's needs, offering a level of customization and responsiveness that is not available in prior art; provide ongoing, cumulative feedback to students by summarizing their progress and highlighting areas of improvement at regular intervals, thereby reinforcing learning and encouraging sustained engagement with the educational content, which contrasts with the more transactional, one-off feedback mechanisms found in traditional educational tools, wherein the vocabulary assessment module is further configured to: incorporate distractors, or unused definitions, alongside correct vocabulary terms during assessment probes to evaluate not only the student's content mastery but also their critical thinking and decision-making skills; analyze student responses to identify tendencies to choose distractors or incorrect definitions and use this data to refine instructional strategies, ensuring that the system addresses specific cognitive challenges faced by the student; provide educators with insights into common distractors and missed vocabulary words chosen by students across the classroom, helping to identify potential misconceptions or areas of confusion that may require additional instructional focus, wherein the Retrieval Augmented Generation (RAG) chatbot module is further configured to: monitor student engagement levels during interactions, using metrics such as response time, frequency of interactions, and the depth of student responses to tailor future dialog and content delivery; dynamically adjust the tone, pacing, and complexity of the chatbot's dialog to maintain or increase student engagement, ensuring that the learning experience remains compelling and aligned with the student's cognitive and emotional state; alert educators when significant drops in student engagement are detected, providing recommendations for re-engagement strategies or alternative instructional approaches, wherein the instructor insights module is further configured to: continuously compare individual student performance data against both aggregated classroom-level and longitudinal historical data, enabling dynamic identification of deviations from expected learning trajectories in real-time, in contrast to traditional point-in-time assessments; generate customized, dynamic reports that evolve with the student's progress, detailing trends in performance, areas of consistent strength, and persistent content gaps that require ongoing attention, thus offering a more nuanced and actionable understanding of each student's learning profile compared to static performance snapshots; recommend differentiated instructional strategies that are continuously updated based on real-time analysis of student progress, such as personalized learning plans, targeted group interventions, or adaptive content delivery, ensuring that instructional approaches remain relevant and responsive to the student's current learning needs, wherein the vocabulary assessment module is further configured to: utilize a randomized selection process for vocabulary terms across the entire course curriculum, ensuring that each assessment provides a holistic evaluation of content mastery by including terms from both recently taught material and earlier concepts, thereby offering a more comprehensive understanding of student knowledge retention over time compared to traditional point-in-time assessments that focus on recent instruction; analyze student response patterns not only to measure immediate comprehension but also to track long-term retention and integration of knowledge across different subject areas, providing educators with insights into the durability of student learning and the effectiveness of their teaching methods, which are insights typically overlooked by traditional assessments; deliver assessment results in real-time to the Retrieval Augmented Generation (RAG) chatbot module, enabling the chatbot to instantly adapt its instructional content and engagement strategies based on the student's demonstrated retention and understanding, thereby offering an immediate and personalized response to learning challenges, which contrasts with the delayed feedback typical of traditional assessment tools, wherein the dynamic metadata-driven taxonomy is further configured to: enable educators to personalize vocabulary assessments by aligning selected vocabulary terms directly with the specific content and learning objectives of their classroom curriculum, thereby ensuring that the vocabulary terms tested are immediately relevant to the students' current course of study, which contrasts with traditional systems that often rely on static, pre-packaged content that may not fully align with the individual classroom curriculum; provide a standardized method for early identification of at-risk students by utilizing a uniform framework for analyzing student performance on personalized vocabulary assessments, allowing for consistent detection of learning difficulties across diverse educational contexts and subject areas, thereby enabling timely and targeted interventions that are data-driven and standardized across different classrooms and schools; support comprehensive and standardized growth tracking across virtually all subjects and grade levels, from post-3rd grade in K-12 through post-secondary education, by applying a consistent set of metrics and criteria to evaluate student progress over time, which facilitates comparisons across different educational stages and ensures that learning outcomes are being met in a uniform and measurable manner, a significant advancement over traditional assessments that may lack such standardization and comparability across diverse educational settings; dynamically adapt to curriculum changes, educational standards, and emerging pedagogical research by updating its metadata-driven framework, ensuring that the vocabulary assessments remain aligned with the most current educational goals and practices, thereby providing a flexible and responsive tool for educators, unlike traditional assessment systems that may become outdated and less relevant as educational priorities evolve, wherein the Retrieval Augmented Generation (RAG) chatbot module is further configured to: facilitate personalized, ongoing instructional conversations with students based on real-time analysis of their performance data, ensuring that each interaction is tailored to address the student's specific learning needs, challenges, and progress, a capability that extends beyond the static feedback typically provided by traditional educational tools; dynamically integrate new instructional content, tailored exercises, and targeted feedback into these conversations based on the student's evolving understanding, thereby creating a continuous, adaptive learning environment that is responsive to the student's development over time; provide contextual explanations and reinforcement of concepts directly related to the vocabulary terms and content areas where the student has demonstrated weaknesses, ensuring that the chatbot's interventions are directly aligned with the student's learning trajectory and the curriculum, unlike prior art systems that may rely on generic or non-specific interventions, wherein the assessment module is further configured to: perform integrated longitudinal analysis by continuously aggregating and examining student performance data from consistent weekly assessment probes, thereby providing an ongoing, evolving picture of both short-term comprehension and long-term knowledge retention, offering a dynamic understanding of student learning over time that contrasts with the static, point-in-time snapshots typical of traditional assessments; utilize advanced machine learning algorithms that dynamically adapt to new data collected from these weekly probes, generating predictive models that forecast future student performance and identify potential areas of difficulty, enabling early, personalized interventions that evolve with the student's learning trajectory, which significantly differs from the fixed nature of traditional predictive tools; deliver continuously updated comparative analytics, wherein the system benchmarks individual student progress against aggregated peer data, adjusting these benchmarks in real-time as new weekly assessment data is integrated, thus providing educators with a constantly refreshed, contextually relevant view of student growth relative to both individual progress and the evolving performance trends within the classroom or educational community, wherein the Retrieval Augmented Generation (RAG) chatbot module is further configured to: conduct post-assessment dialogs with students immediately following the weekly vocabulary assessment probes, providing tailored feedback and instructional content that directly addresses the student's specific errors and misconceptions, thereby reinforcing correct understanding and facilitating immediate corrective learning, a capability that contrasts with traditional educational systems that often delay feedback until assessments are manually reviewed; leverage the ongoing results from these post-assessment dialogs to adjust the chatbot's future interactions and instructional strategies, ensuring that subsequent engagements are informed by the student's evolving learning needs and progress, creating a continuously adaptive learning environment; store and analyze data from these dialogs to identify broader patterns of misunderstanding or persistent challenges among students, enabling the system to refine its instructional content and strategies at both the individual and classroom levels, offering a dynamic and data-driven approach to learning that surpasses the static, one-size-fits-all methods of prior educational technologies, wherein the instructor insights module is further configured to: automatically generate and distribute periodic reports to educators, summarizing individual and classroom-level performance trends derived from the continuous weekly assessment data, offering insights into both the effectiveness of instructional strategies and areas requiring further attention, thereby enabling educators to make data-driven decisions that are more timely and precise than those supported by traditional, less frequent assessment reports; provide actionable recommendations within these reports, such as specific re-teaching strategies, differentiated instruction techniques, and suggestions for integrating additional resources, based on identified trends and patterns in student performance data, ensuring that educators receive targeted guidance that aligns with the current needs of their students; include predictive analytics in the reports that forecast potential future challenges and opportunities for student growth, based on historical and real-time data, enabling educators to proactively adjust their instructional approaches to better support student outcomes, a feature that significantly enhances the proactive capabilities of the system compared to traditional assessment tools that often lack real-time forecasting, wherein the Retrieval Augmented Generation (RAG) chatbot module is further configured to: adapt its instructional content delivery based on the context and difficulty of the vocabulary terms identified as areas of weakness, ensuring that the explanations, examples, and exercises provided are appropriately tailored to the student's current understanding and cognitive level, thereby maximizing the effectiveness of the learning intervention compared to static content delivery methods in traditional educational tools; facilitate scaffolding techniques within its dialog, where the complexity of instructional content is gradually increased as the student demonstrates improved understanding, enabling a more structured and supportive learning progression that is tailored to the student's pace, a feature that distinguishes the system from prior art that often lacks such adaptive scaffolding capabilities; integrate motivational elements, such as positive reinforcement and goal-setting, into its interactions to enhance student engagement and persistence, offering a more holistic and supportive learning experience that contrasts with the more transactional and feedback-focused interactions typical of prior educational technologies, wherein the dynamic metadata-driven taxonomy is further configured to: allow for real-time customization and alignment of vocabulary terms with evolving classroom objectives, enabling educators to update and refine the vocabulary assessment criteria as new content is introduced or as the focus of the curriculum shifts, providing a level of adaptability that surpasses the static nature of traditional assessment systems; support cross-curricular integration by linking vocabulary terms with related concepts across multiple subjects, thereby facilitating interdisciplinary learning and helping students make connections between different areas of study, a capability that contrasts with prior art, which often treats subject areas in isolation; maintain a historical record of vocabulary term usage and student performance data, enabling educators to track the effectiveness of specific vocabulary interventions over time by analyzing long-term trends and patterns in student learning, thus providing a data-driven approach to refining instructional practices that is significantly more comprehensive and actionable than the typically fragmented, point-in-time data provided by traditional educational systems, wherein the Retrieval Augmented Generation (RAG) chatbot module is further configured to: provide context-aware instructional content that adapts not only to the student's performance data but also to the specific time of day, recent interactions, and current academic workload, ensuring that the content delivered is relevant and conducive to the student's optimal learning conditions, a feature that enhances engagement and retention compared to traditional systems that deliver static content regardless of the student's current context; dynamically adjust the tone and complexity of the language used in interactions based on the student's emotional state and engagement level, as inferred from their interaction patterns and response times, thereby creating a more supportive and responsive learning environment that is particularly beneficial for maintaining motivation and reducing frustration, contrasting with the one-size-fits-all communication style of prior art; leverage a personalized learning profile that evolves with each interaction, allowing the chatbot to recognize patterns in the student's learning behavior and preferences, and use this information to tailor future interactions, creating a highly individualized learning experience that continuously adapts to the student's needs, wherein the dynamic metadata-driven taxonomy is further configured to:enable educators to define and incorporate custom vocabulary sets that align with specialized courses or unique educational programs, such as vocational training, professional certifications, or advanced placement courses, thereby ensuring that the system can support a wide range of educational contexts beyond standard K-12 and post-secondary curricula, offering a level of flexibility and customization that is not typically available in traditional assessment systems; support the automatic tagging and categorization of these custom vocabulary sets within the existing taxonomy, ensuring seamless integration with the system's assessment and tracking capabilities, thereby allowing for consistent monitoring of student progress and content mastery across both standard and specialized curricula, which enhances the system's utility across diverse educational settings; and allow for the rapid deployment of new vocabulary assessments in response to emerging educational needs or shifts in curriculum focus, ensuring that the system remains relevant and effective in dynamic educational environments, a capability that contrasts with the slower, less adaptable nature of prior art.

In yet another aspect of the present invention, a method for performing vocabulary matching measure assessment provides the following: receiving, by a vocabulary assessment system, vocabularies associated with one or more courses; receiving, by the vocabulary assessment system, inputs associated with one or more words and one or more definitions associated with the one or more words from a learner; receiving, by the vocabulary assessment system, a command from the learner to submit a probe; and outputting, by the vocabulary assessment system, probe results based on the inputted one or more words and the one or more definitions, wherein the processing unit continuously monitors student progress by analyzing the results of vocabulary probes and updating performance data in real-time; further providing an early detection module configured to identify learning gaps based on the analysis of vocabulary probe results and alert educators for timely intervention, wherein the processing unit integrates a Retrieval Augmented Generation (RAG) Large Language Model (LLM) to access a customizable corpus of educational content and generate contextually appropriate and accurate responses based on areas of student weakness, further providing a personalization module that adapts learning content based on individual student performance and learning needs, providing a tailored educational experience, wherein the output module provides real-time feedback to students, offering immediate explanations and examples tailored to their vocabulary knowledge and content understanding, wherein the system employs a dynamic taxonomy and metadata-driven architecture to ensure seamless integration into various curriculum structures and educational settings, wherein the vocabulary matching measure assessment is based on curriculum-based measurement (CBM) principles to provide a consistent and scalable method for evaluating student progress across different subjects and educational levels, further providing an interactive RAG-based chatbot configured to engage students in conversational learning, providing personalized assistance and enhancing content knowledge through vocabulary acquisition, wherein the output module generates data-driven insights for educators, offering detailed analysis of student progress, performance trends, and areas of struggle, informing instructional decisions and support strategies, wherein the real-time growth tracking dashboards and interactive nature of the RAG-based chatbot boosts student engagement, improves information retention, motivation, and overall attitude toward learning through personalized and dynamic interactions, wherein the system is scalable and applicable across various educational levels, from K-12 to post-secondary education, ensuring consistent progress monitoring and support, further providing an alert module that automatically notifies educators of significant changes in student performance or identified learning gaps, enabling prompt and targeted interventions, wherein the system is designed to integrate seamlessly with existing educational systems and platforms, enhancing its applicability and ease of implementation, wherein the personalization module adapts learning content to cater to diverse learning needs, including students with special educational requirements, wherein the storage unit synchronizes data in real-time, ensuring that student performance data is always up-to-date and accessible for analysis and reporting, wherein the system supports multiple languages, enabling vocabulary assessments and learning support for students in different linguistic contexts, wherein educators can customize vocabulary probes to align with specific curriculum goals and learning objectives, providing targeted assessments, wherein the system employs secure data management practices to protect student information and ensure privacy and compliance with educational data regulations, wherein the RAG-based chatbot can integrate with external educational resources and databases, expanding the scope of available content for personalized learning assistance, wherein the system tracks student performance longitudinally, providing insights into long-term learning trends and the impact of interventions over time, further providing dashboards for teachers and students, providing an overview of student performance and growth, wherein the predictive analytics module utilizes historical data from vocabulary probes to predict student outcomes, such as end-of-course grades and overall academic success, further providing a rate of improvement analysis tool that calculates the rate at which individual students improve their vocabulary scores over time, providing insights into their learning trajectory and effectiveness of interventions, wherein the vocabulary probes are designed and validated using research-based psychometrics to ensure their reliability and validity as indicators of student performance and content mastery, wherein the vocabulary matching measure is applicable across various academic subjects and educational levels, from K-12 to post-secondary education, enabling comprehensive assessment and support in disciplines such as science, mathematics, social studies, language arts, and various post-secondary programs of study, including but not limited to Medicine and Health Sciences, Engineering and Applied Sciences, Natural Sciences, Social Sciences, Business Management, Education and Training, Law and Legal Studies, Information Technology, and the Humanities, and wherein the real-time data and insights generated by the system enhance curriculum implementation by providing educators with the information needed to make data-driven adjustments and improvements to their teaching strategies.

The present disclosure describes a system and method that leverages the strong correlation between vocabulary knowledge and content mastery to identify at-risk students and those whose academic growth is not progressing as expected. By monitoring vocabulary acquisition and retention, the system provides early identification of students who may need additional support. The system conducts continuous vocabulary matching assessments using a dynamic, metadata-driven taxonomy that adapts to diverse educational curricula. Vocabulary terms are aligned with specific course content, allowing the system to dynamically generate assessment probes that track student progress throughout the course. A key feature of the system is its integration of a ChatBot, which engages both students and instructors in proactive, real-time interactions. The ChatBot analyzes student performance data and offers personalized, targeted feedback to students, helping them improve their content knowledge, based on their current vocabulary knowledge (or lack thereof). For instructors, the ChatBot provides insights and strategic recommendations for interventions, ensuring that instructional adjustments are made promptly and effectively. This system offers a level of one-to-one support and personalized intervention that current classroom systems cannot provide at scale, ultimately enhancing educational outcomes by fostering continuous engagement and tailored learning experiences. Traditional systems lack the capability to deliver such individualized, real-time support, making this system a significant advancement in personalized education. This system provides a personal learning assistant to each learner; one that understands the learner's struggles, and proactively engages in an adaptive manner to best provide interventions and supports, while also advising the instructor, to help the learner reach the best possible outcomes.

In still yet another aspect of the present invention, a system for employing taxonomy-based classifications to generate vocabulary matching assessments for a student in a course curriculum provides the following: a systemic database that receives educational content data and institutional organization data from one or more sources of educational information; a taxonomy module that processes the institutional organization data to generate taxonomy-based classifications of the institutional organization data, wherein at least one taxonomy-based classification is a course having the course curriculum; a content loading module configured to associate vocabulary terms embedded in the educational content data with the course based on, for each associated vocabulary term, metadata derived from a relationship between the associated vocabulary term and the taxonomy-based classifications; and a probe module configured to administer a plurality of periodic vocabulary matching assessments to the student, wherein each vocabulary matching assessment includes one or more associated vocabulary terms.

In another aspect of the present invention, the system for employing taxonomy-based classifications to generate vocabulary matching assessments for a student in a course curriculum further provides the following: wherein the probe module is further configured to establish, from previously administered vocabulary matching assessments, a baseline and a trendline based on each of the previously administered vocabulary matching assessments, wherein the trendline is updated in real-time; further providing a retrieval augmented generation chatbot (RAGC) module, wherein the RAGC module incorporates a customizable corpus of supplemental instructional content, and wherein the RAGC module is configured to provide conversational feedback to the student, wherein the conversational feedback is based on the customizable corpus of supplemental instructional content and the trendline, wherein the RAGC module is configured to provide conversational feedback to an instructor of the student, wherein the conversational feedback is based on the customizable corpus of supplemental instructional content and the trendline, wherein the RAGC module is further comprises a hierarchical navigable functionality, wherein the customizable corpus of supplemental instructional content comprises a corpus of instructional strategies, and wherein the hierarchical navigable functionality identifies at least one of the instructional strategies of the corpus of instructional strategies so that the conversational feedback comprises identified instructional strategies, wherein the hierarchical navigable functionality builds a layered graph structure where vectors connect strategic content of each of the instructional strategies and trendline content of the trendline, wherein trendline content is based on at least one associated vocabulary term of at least one previously administered vocabulary matching assessments; further providing an instructor insight module configured to generate a report comprising the baseline and the trendline, wherein the relationship between the associated vocabulary term and the taxonomy-based classifications is based on vector indexing, wherein the institutional organization data comprises a plurality of educational settings, a plurality of subjects, a plurality of courses of which the course is one, and one or more course levels for each course of the plurality of courses, wherein the taxonomy module defines a matrix of nested hierarchies from said pluralities of educational settings, subjects, courses, and course levels, and wherein the plurality of educational settings comprises educational levels from kindergarten to post-secondary education, and wherein each said educational level defines a nested hierarchy of at least one subject, course and course level, respectively.

These and other features, aspects, and advantages of the present invention will become more apparent with reference to the following detailed description and accompanying drawings.

### BRIEF DESCRIPTION OF THE DRAWINGS

Illustrative embodiments of the present invention are described herein with reference to the accompanying drawings, in which:

FIG. 1 depicts a flow chart of an exemplary embodiment of an administrator user story of a vocabulary matching measure assessment system in accordance with present invention.

FIG. 2 depicts a flow chart of an exemplary embodiment of a chatbot user story of the vocabulary matching measure assessment system in accordance with the present invention.

FIG. 3 depicts a flow chart of an exemplary embodiment of an instructor user story of the vocabulary matching measure assessment system in accordance with the present invention.

FIG. 4 depicts a flow chart of an exemplary embodiment of a learner user story of the vocabulary matching measure assessment system in accordance with the present invention.

FIG. 5 depicts a block diagram of an exemplary embodiment of the vocabulary matching measure assessment system in accordance with the present invention.

### DESCRIPTION OF INVENTION

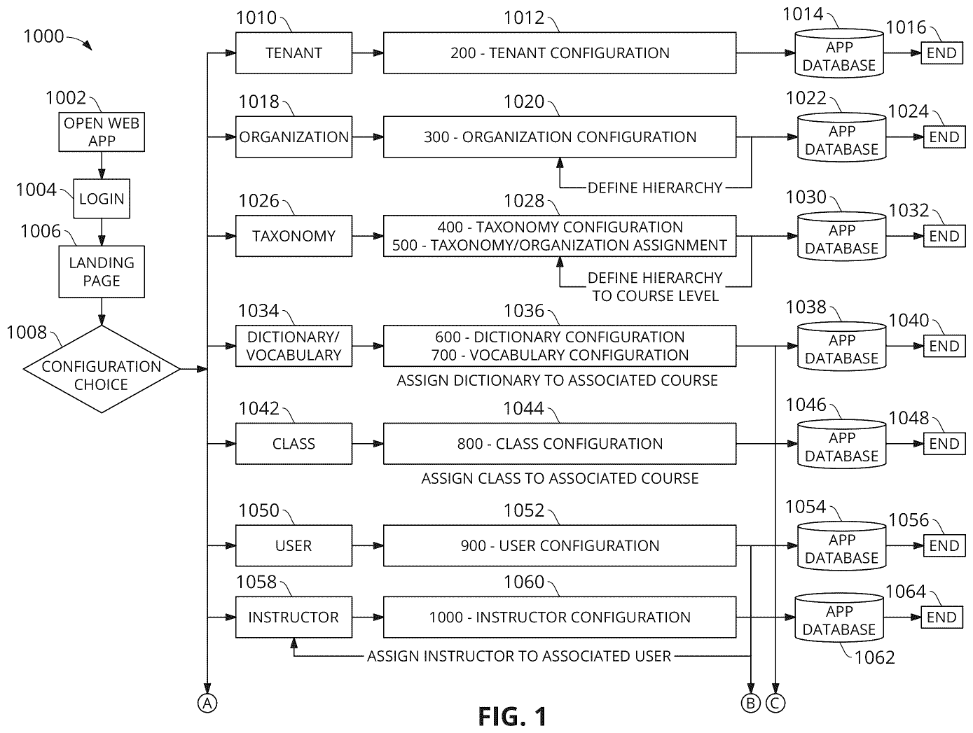

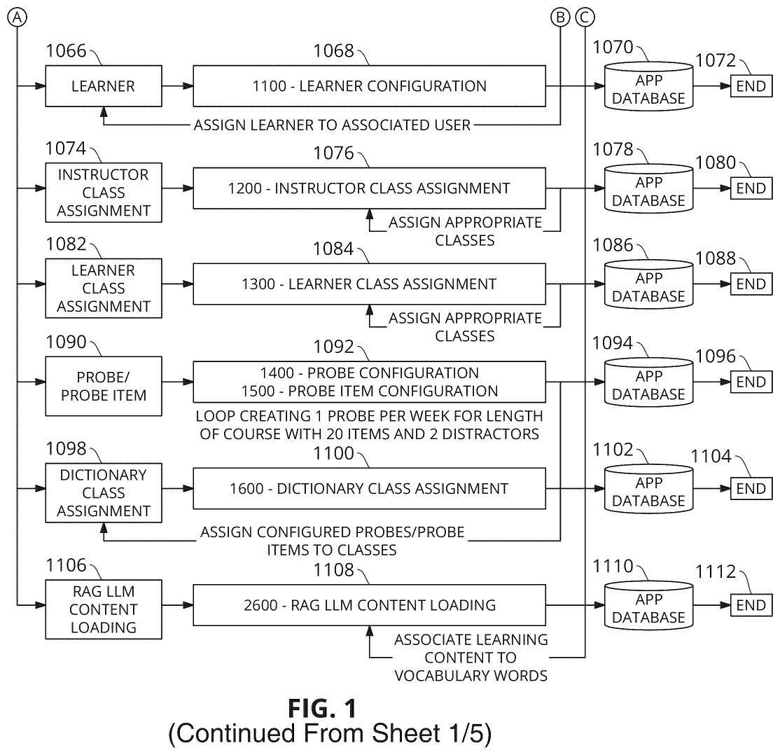

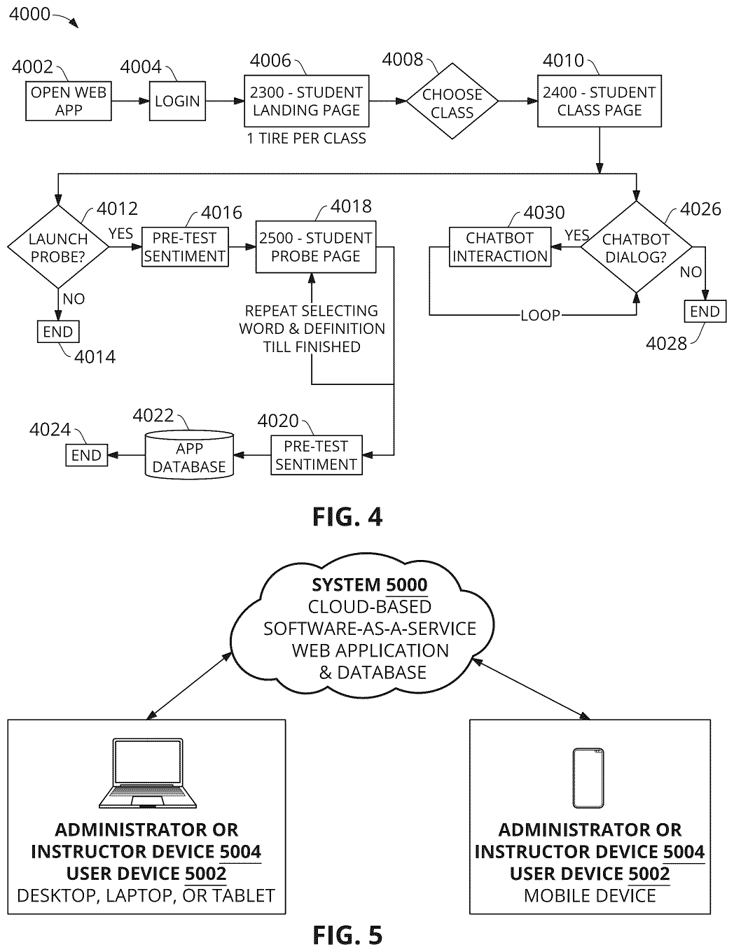

FIGS. 1 through 5 depict an example vocabulary matching measure assessment system 100 (or system 100) in accordance with embodiments of the invention.

The system 100 may be hosted on a server and may be communicatively coupled with a user device 102 and one or more institutional devices 104. The user device 102 may be associated with a student, and the institutional device 104 may be associated with a system administrator or an instructor or a teacher of an education institution. The system 100 may be configured to provide a universal framework that delivers continuous assessment and progress monitoring of student growth and the maintenance of skills over time. The system 100 may provide a single, consistent solution, utilizing vocabulary matching as a curriculum-based measurement to assess and monitor student progress across virtually all subjects and grade levels spanning K-12 and higher education institutions. This continuous monitoring facilitates early identification of struggling students, as the system 100 is designed to deliver weekly periodic assessments which are automatically scored and graphed, which provide the instructors with the ability to quickly see who is not making adequate progress in the course content and intervene to provide supplemental instruction when needed. The periodic assessments may last for a predetermined period, such as but not limited to five minutes.

The system 100 may be a Software as a Service (SaaS) solution. When a new customer is acquired, there are several steps performed by an administrator as shown in FIG. 1. The first step is Tenant Configuration 200, which represents onboarding a new customer and associated unique identifier in the system user interface. Once the tenant is configured, then Organization Configuration 300 is used to define the structure of the educational organization. This can be a nested hierarchy, such as a school district and associated schools or a university and associated colleges/schools/programs.

Once the organization(s) configuration is complete, the next step involves creating the education level, educational content domains, and course hierarchy/taxonomies in the Taxonomy Configuration 400. This taxonomy is a structured metadata framework that is later utilized to assign the appropriate dictionary and associated vocabulary to specific course offerings. For instance, in a university setting, the taxonomy is organized across several levels. At Level 1, the taxonomy may be designated as “University/Campus” to represent the overarching institution, such as “State University” or “Urban Campus.”

At Level 2, the taxonomy might be classified as “College/School,” representing the various colleges or schools within the university, such as the “School of Nursing,” “College of Engineering,” or “School of Business.”

Moving further, Level 3 could be categorized as “Course Level,” which specifies the academic level of the courses offered within the colleges or schools. Examples include “Level 100”, “Level 300”, “Undergraduate Level,” “Graduate Level,” or “Professional Certification Level.”

Finally, at Level 4, the taxonomy might be defined as “Course Offering,” identifying specific courses available within a department or program, such as “Fundamentals of Nursing,” “Advanced Thermodynamics,” or “Business Ethics.”

Similarly, for a K-12 educational setting, the taxonomy can be adapted accordingly. At Level 1, the taxonomy might be designated as “Grade Level,” such as “5th Grade,” “8th Grade,” or “12th Grade.”

At Level 2, it could be categorized as “Subject,” encompassing various subject areas like “Mathematics,” “Science,” “English Language Arts,” or “Social Studies.”

Level 3 would then be “Course,” identifying specific courses within each subject, such as “Algebra I,” “Physical Science,” “American Literature,” or “World History.”

This hierarchical taxonomy structure ensures that the system can be tailored to align with the unique educational objectives and curricular standards of any institution, whether it be a large university with diverse academic programs, or a K-12 school system with varying grade levels and subjects. This flexibility allows the vocabulary assessment system to provide relevant and contextually appropriate content across a wide range of educational environments, ensuring that each student's progress is tracked and assessed with precision.

The dynamic hierarchical taxonomy described herein offers several benefits that significantly enhance the flexibility and adaptability of the vocabulary assessment system. Unlike traditional systems that often rely on static and rigid taxonomies, this dynamic framework allows for real-time customization and alignment with evolving educational objectives. By supporting multiple levels of organization—from broad institutional structures like universities and school districts to specific courses within a curriculum—this taxonomy ensures that the system can be seamlessly integrated into any educational environment, regardless of its complexity or scale.

One of the key advantages of this approach is its ability to accommodate the diverse and changing needs of educational institutions. For example, a university can easily expand its taxonomy to include new schools or departments, such as adding a “School of Data Science” within its existing structure. Similarly, a K-12 school district can quickly adapt to changes in educational standards or curriculum updates by modifying the taxonomy to reflect new grade levels, subjects, or courses. This adaptability not only streamlines the process of curriculum alignment but also allows educators to ensure that the vocabulary assessments remain relevant and contextually appropriate for their students.

Moreover, the metadata-driven nature of this taxonomy enables the system to automatically adjust vocabulary selections and assessments based on the specific context of each course or subject. This means that students are assessed on vocabulary that is directly tied to the content they are currently learning, as the instructor assigns specific vocabulary terms aligned with the course's taxonomy hierarchy prior to the start of instruction. The instructor selects the appropriate vocabulary by navigating the taxonomy, which organizes course material into relevant content areas, ensuring that the vocabulary list directly corresponds to the subject matter being taught. As a result, the assessments are not generic but are specifically tailored to the instructional material, providing a more accurate and meaningful measure of student progress. For educators, this translates into more actionable insights, as the system can identify trends and areas of weakness that are directly related to the specific content being taught, rather than relying on generic or one-size-fits-all assessments. This level of customization and responsiveness represents a significant advancement over traditional assessment tools, making the system not only more effective but also more efficient in supporting student learning and instructional planning.

Once the taxonomies are defined, appropriate taxonomies may be assigned to the corresponding organization(s) in Taxonomy/Organization Assignment 500. This is defining which specific taxonomies show up for which organizations. Once this is completed, the next step is Dictionary Configuration 600, which creates a dictionary for a specific course offering that was defined in the taxonomies. Then Vocabulary Configuration 700 associates the words and definitions to the appropriate Dictionary that was defined in the prior step.

Class Configuration 800 creates an instance of a course offering with its Organization Configuration 300 so that a class is associated with its organization. User Configuration 900 is onboarding of users and associated email address and password. Instructor Configuration 1000 creates instructors associated with the Organization Configuration 300 and the User Configuration 900 so that an instructor is associated with a login and an organization. Learner Configuration 1100 creates learners associated with the Organization Configuration 300 and the User Configuration 900 so that a learner is associated with a login and an organization.

Instructor Class Assignment 1200 associates the Instructor Configuration 1000 with the Class Configuration 800. Learner Class Assignment 1300 associates the Learner Configuration 1100 with the Class Configuration 800. Probe Configuration 1400 creates the set of assessments (probes) for the Dictionary Configuration 600. Probe Item Configuration 1500 creates the individual list of words associated with the Probe Configuration 1400. Dictionary Class Assignment 1600 associates the Dictionary Configuration 600 and the Probe Configuration 1400 with Class Configuration 800.

The RAG LLM Content Loading 2600 module represents a pivotal innovation in the vocabulary assessment system, providing an intuitive interface that allows administrators to load supplemental instructional content directly into the system. This content is then meticulously tagged with the appropriate vocabulary words, creating a rich, contextually relevant repository that the Retrieval Augmented Generation (RAG) Large Language Model (LLM) chatbot can draw from to deliver precise and impactful educational support. This feature is not merely a content management tool; it is integral to the system's ability to deliver personalized, curriculum-aligned interventions that are tailored to the specific needs of each learner.

A key novel aspect of the RAG LLM Content Loading 2600 is its dynamic integration with the system's hierarchical taxonomy. As administrators load supplemental content, the RAG LLM Content Loading 2600 module automatically scans the content for embedded vocabulary terms. Embedded vocabulary terms are identified by comparing the terms within the supplemental content to the existing vocabulary words stored in the system's dictionaries, which have been previously loaded by administrators and/or instructors for the relevant courses and subjects. Upon identifying these terms, the system searches the hierarchical taxonomy and aligns the supplemental resources with the corresponding educational objectives, subjects, and courses. This process automates the tagging of content, ensuring that it is correctly assigned to the relevant courses without requiring manual input. For example, when content related to “Nursing Ethics” is uploaded, the system scans for relevant vocabulary, cross-references the taxonomy, and automatically assigns the content to the appropriate educational modules within the School of Nursing. This seamless integration eliminates the need for manual alignment and ensures that the supplemental resources are directly linked to the instructional framework. This level of automation and contextual alignment contrasts sharply with traditional systems, where content tagging and alignment typically require significant manual effort, leading to inefficiencies and potential misalignment with course objectives.

Another novel benefit of the RAG LLM Content Loading 2600 is its ability to continuously update and expand the chatbot's knowledge base in real-time. As new instructional materials are introduced-whether they are new research articles, updated textbooks, or additional learning resources-administrators can quickly incorporate these into the system. This allows the chatbot to remain aligned with the most current educational standards and practices, providing students with the most up-to-date information and instructional support. This dynamic updating process contrasts sharply with traditional online assessment systems, where the content repositories often remain static and become outdated over time, limiting their effectiveness in supporting ongoing student learning.

Furthermore, the tagging process in the RAG LLM Content Loading 2600 is designed to be highly granular, allowing for the differentiation of content based on various factors such as difficulty level, subject specificity, and educational goals. This granularity enables the chatbot to deliver content that is not only relevant but also appropriately challenging for each student's current level of understanding. For instance, a student struggling with foundational concepts in “Algebra I” can be provided with supplemental content that reinforces basic algebraic principles, while an advanced student can be directed toward more complex problem-solving exercises. This personalized approach to content delivery is a significant improvement over traditional Internet educational assessment systems that often provide generic resources without considering the individual needs and progress of each student.

The RAG LLM Content Loading 2600 also offers non-obvious advantages in terms of instructional planning and resource management. By centralizing the management of supplemental content and aligning it with the system's taxonomy, educators can more effectively plan and coordinate their instructional strategies. The system's ability to track which content has been tagged and utilized in different courses or subjects allows administrators to identify gaps in the instructional resources and address them proactively. This capability ensures that the educational institution's curriculum remains robust, comprehensive, and fully aligned with its pedagogical objectives.

In summary, the RAG LLM Content Loading 2600 is a novel and integral component of the vocabulary assessment system, providing a sophisticated, dynamic, and responsive mechanism for managing instructional content. By enabling real-time updates, granular content tagging, and seamless integration with the system's taxonomy, this feature significantly enhances the system's ability to deliver personalized, curriculum-aligned educational support to both students and instructors. This level of customization and adaptability represents a substantial improvement over existing computer-based scholastic assessment systems, positioning the vocabulary assessment system as a leading tool in modern education.

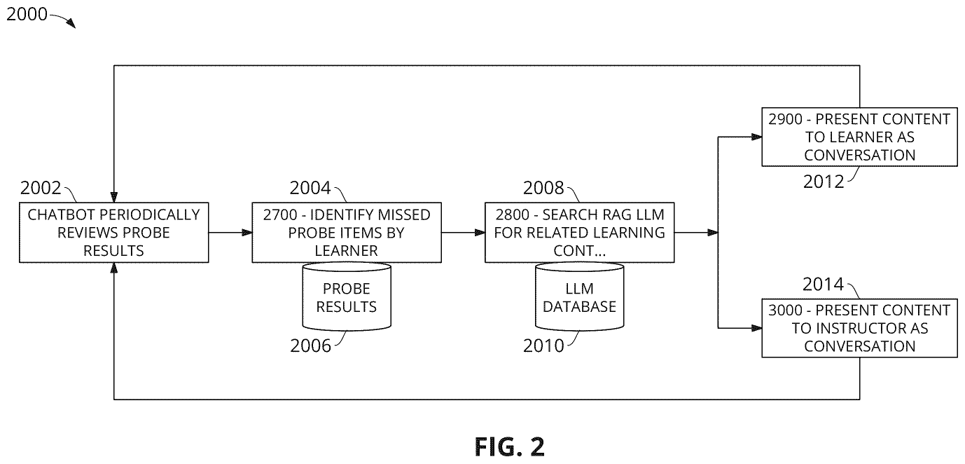

Once an administrator completes configuration, instructors can interact with the system, as shown in FIG. 3. Teacher Landing Page 1700 displays the Instructor Class Assignment 1200 for a given Instructor Configuration 1000. Teacher Class Progress Page 1800 displays the Class Configuration 800 and the results for the Dictionary Class Assignment 1600. Additionally, Teacher Class Progress Page allows the instructor to interact with the ChatBot to gain insights and recommendations based on vocabulary words that learners frequently miss. The ChatBot utilizes RAG to pull from a customized corpus of educational materials, providing the instructor with detailed explanations, teaching strategies, and additional resources to address specific vocabulary gaps identified through student probe results. Teacher Class Probes Page 1900 displays summary of the Dictionary Class Assignment 1600 and next available Probe Configuration 1400. Teacher Class Probe Enable 2000 activates probe for the Dictionary Class Assignment 1600. Teacher Class Dashboard Page 2100 displays charts for the Dictionary Class Assignment 1600. Teacher Class Vocabulary Page 2200 displays the Vocabulary Configuration 700 for the Dictionary Classroom Assignment 1600.

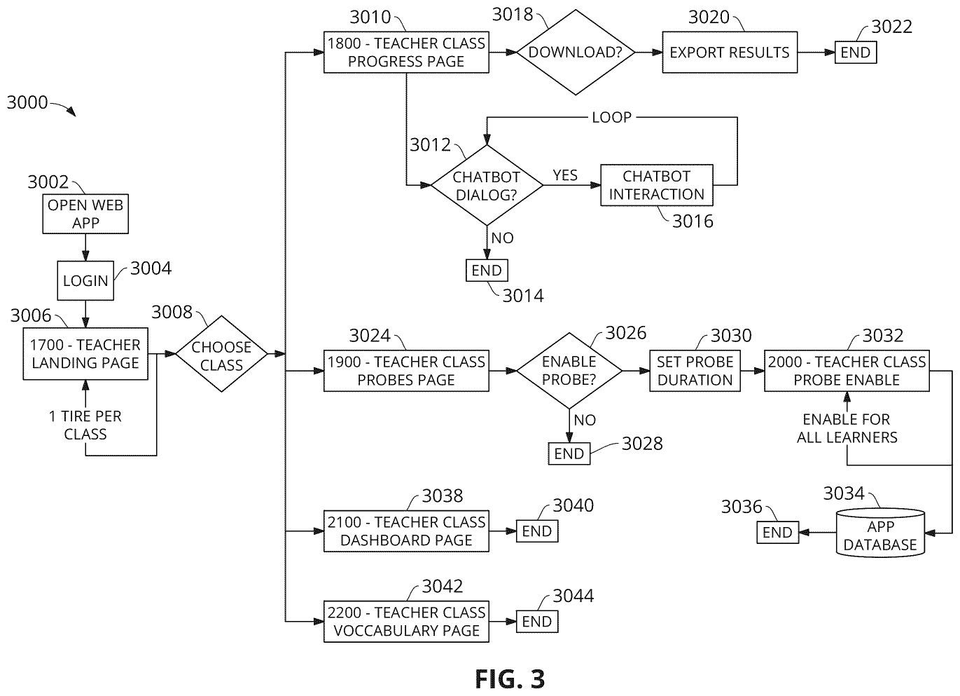

Once an instructor completes configuration of their classes, learners can interact with the system, as shown in FIG. 4. Student Landing Page 2300 displays the Learner Class Assignment 1300 for a given Learner Configuration 1100. Student Class Page 2400 displays a specific Class Configuration 800, the results for Dictionary Class Assignment 1600 for the specified Learner Configuration 1100 and optionally, a button to take the next probe for the Dictionary Class Assignment 1600. Additionally, Student Class Page 2400 allows the learner to engage with the ChatBot in a conversational mode to receive supplemental instruction on vocabulary words they struggled with in their probes. The ChatBot, powered by Retrieval Augmented Generation (RAG), retrieves relevant information and presents it in an easy-to-understand, engaging manner, enhancing the learner's comprehension and retention of the vocabulary. Student Probe Page 2500 is a student taking a specific Probe Configuration 1400 and storing results in the Dictionary Classroom Assignment 1600.

In operation, an administrator, via the institutional device 104, may add a new organization (i.e., a high school) by configuring a tenant and adding the high school as an organization of the tenant. The administrator may then work with the high school to define the taxonomies (i.e., grade levels, subjects, courses) and the associated dictionaries (essential vocabularies) for each course. The administrator may then configure the taxonomies such as: Level 1—Grade Level (i.e., 9th, 10th); Level 2—Subject (i.e., Mathematics, Science); Level 3—Course (i.e., Algebra 1, Biology). The administrator may then configure the dictionaries for the associated courses (i.e., Algebra 1 vocabulary). The administrator may next configure the classes (instances of a course), add the users, create instructors and learners and associate them with the appropriate user ID. Then the administrator may associate instructors and learners with the appropriate classes. The administrator may then determine the number of probes for a course based on the length of the course and generate the appropriate number of probes, which would assign the dictionaries and associated probes to the classrooms. At this point, instructors and learners may be able to login and access their classes.

An instructor may log into his/her landing page and see his/her classes (listed as individual tiles). The instructor may click on a class, which would bring the instructor to the progress page for that class showing the results by student of any probes that have been given, shown as line graphs. The instructor may click on the probes tab to open the probes page which will show the list of completed probes and the next available probe with a button to enable the next probe for learners to complete. The instructor may click the “Enable Probe” button which opens a dialog box for the instructor to specify the duration of time the probe may be available to be taken (in minutes) and then click the button to start the probe.

A learner may log into their landing page and see their classes (listed as individual tiles). The learner may click on a class, which would bring them to a class detail page showing the results of any completed probes as a line chart, and if a probe is ready to be taken, a button for the student to complete the next probe. When the learner clicks the “Launch Probe” button, they will view a probe page that has a timer counting down showing remaining time. Below the timer is the list of words as clickable buttons, and below the words is a scrollable window of definitions associated. The learner reads a definition in the list, clicks the word they choose for that definition, then clicks the definition to associate the word next to the definition. The learner repeats this process for as many definitions as they can. Once they have finished, the learner clicks “Submit” to complete the probe. The learner is returned to the class detail page and is shown their resulting score for the probe along with any prior probes.

Using the process described above, the system provides both learners and instructors with a comprehensive, ongoing understanding of student knowledge and progress. The weekly probes are designed to be brief, requiring only approximately five minutes to complete, yet they yield rich, actionable data that is immediately available for analysis. This frequent assessment cycle allows instructors to quickly identify students who may be struggling, facilitating timely interventions that are tailored to the specific areas where a student is encountering difficulties. The data generated by these probes is quantitative, offering clear, objective insights into each student's performance trends over time.

A distinctive feature of this system is its seamless integration with the Retrieval Augmented Generation (RAG) chatbot, which acts as a collaborative partner for the instructor. As soon as a student completes a probe, the ChatBot analyzes the results in real-time by referencing the student's performance against predefined educational benchmarks, the assigned vocabulary, and relevant supplemental learning content that has been loaded and automatically tagged via the RAG LLM Content Loading 2600 module. This supplemental content is aligned with specific course objectives and vocabulary terms, enabling the RAG ChatBot to deliver highly relevant and personalized feedback. The ChatBot engages the student in a conversational mode, adjusting its responses and content based on the student's interactions. Through this interactive dialogue, the ChatBot provides explanations, rephrases difficult concepts, or offers additional practice exercises tailored to the specific vocabulary terms that the student struggled with. For the instructor, the RAG system generates recommendations by evaluating trends in the student's performance, cross-referencing the difficulty of the content with the student's progress. It also considers the student's prior assessments and overall class performance, allowing the ChatBot to suggest targeted interventions, such as re-teaching strategies or additional resources from the loaded supplemental content, that are specific to the student's needs. This conversational and adaptive approach ensures that the feedback provided evolves in real-time, enhancing both student learning and instructional decision-making through continuous engagement. A chatbot built on a Retrieval Augmented Generation (RAG)-based Large Language Model (LLM) provides personalized and appropriate content by dynamically retrieving relevant information from a predefined, contextually aligned knowledge base, such as supplemental learning materials or course-specific content. The RAG framework integrates both retrieval-based techniques and generative model capabilities, allowing the chatbot to tailor responses based on real-time data, student interactions, and pre-loaded educational content. Content Retrieval: The RAG-based ChatBot has access to a corpus of supplemental learning materials, which are automatically tagged and aligned with specific educational objectives and vocabulary via the RAG LLM Content Loading 2600 module. When a student interacts with the ChatBot, the system retrieves the most relevant content based on the student's specific needs, such as vocabulary gaps or incorrect answers identified in recent assessments. Contextual Understanding: Using the student's performance data—such as results from previous vocabulary probes, historical trends, and real-time responses—the ChatBot understands the context of the student's learning journey. It identifies specific areas of weakness or confusion and retrieves content directly related to those gaps. This allows the ChatBot to deliver feedback or explanations that are specifically tailored to the material the student is struggling with, rather than offering generic information. Conversational Adaptation: The RAG-based ChatBot operates in a conversational mode, adjusting the content it delivers based on the student's responses during the interaction. As the student engages with the chatbot—whether asking for clarification, answering questions, or practicing vocabulary—the system continually adapts its responses. For example, if a student consistently struggles with a certain vocabulary term, the chatbot can provide additional context, simplified explanations, or related examples drawn from the pre-loaded learning resources. Real-Time Personalization: The generative aspect of the RAG framework enables the ChatBot to formulate responses that are not only accurate but also personalized in tone and complexity, based on the student's proficiency level and prior interactions. By combining retrieval from a vast, curated knowledge base with real-time conversational feedback, the ChatBot ensures that the learning experience remains both relevant and adaptive to the student's current performance. Through this combination of contextual retrieval, real-time adaptation, and access to a curated knowledge base, a RAG-based LLM ChatBot is able to provide highly personalized and appropriate content that aligns with the student's immediate learning needs.

The system's ability to universally apply these assessments across any educational content makes it an invaluable tool for educators at all levels, from elementary to post-secondary education. The probes are not only quick and efficient to administer but are also designed to be intuitive and straightforward for all stakeholders, including educators, students, and parents. This ease of use, combined with the collaborative insights provided by the ChatBot, ensures that the system can be effectively implemented and utilized across diverse educational settings. It supports a holistic approach to education, where continuous assessment, immediate feedback, and proactive instructional collaboration drive both student improvement and instructional excellence.

In additional aspects, the process/approach described in the present disclosure may be used as a memory exercise, such as showing a picture and then clicking on associated elements from what the students remember in the picture, or as a word association assessment, such as in psychological testing. In further aspects, the approach may be turned into a brain exercise game that is a speed test (i.e., math equations could be displayed, and the user would see how quickly they could associate the right answer to the equation) which would build the students' automaticity for solving math equations that are needed for more difficult mathematics. Furthermore, for skills in which quick recognition will provide benefit, this approach may be adapted, e.g., work training programs.

The system 100 stands out for its innovative online vocabulary matching approach, which functions as a sophisticated form of curriculum-based measurement (CBM). This approach is not merely a traditional assessment tool; it serves as an active, dynamic indicator of a student's progress throughout the course curriculum. By continuously monitoring vocabulary comprehension, the system provides real-time, quantitative data that educators can utilize to make informed decisions about curriculum planning and instructional adjustments. The continuous flow of data enables a more responsive and adaptive educational environment, where adjustments can be made in near real-time to address emerging needs.

At the core of the system's effectiveness is the foundational principle that vocabulary knowledge is intrinsically linked to overall content mastery and comprehension. The system leverages this strong positive correlation by utilizing vocabulary matching as a key measure of a student's grasp of the course material. Unlike traditional assessments that may only capture a student's understanding of isolated topics at specific points in time, this system continuously tracks vocabulary mastery, offering a more holistic view of student progress. This ongoing assessment allows educators to pinpoint areas where a student may be struggling and intervene promptly, ensuring that learning gaps are addressed before they can widen.

Furthermore, the system's integration with the Retrieval Augmented Generation (RAG) chatbot amplifies its effectiveness. The ChatBot not only delivers real-time feedback to students but also collaborates with instructors by interpreting quantitative data, identifying retention and scoring patterns, and suggesting tailored strategies to enhance student comprehension. The Retrieval Augmented Generation (RAG)-based Large Language Model (LLM) employs advanced vector indexing techniques, such as the Hierarchical Navigable Small World (HNSW) algorithm, to efficiently retrieve relevant content from large datasets and suggest appropriate teaching strategies. This method leverages vector embeddings-numerical representations of data points such as vocabulary terms, student performance metrics, and instructional strategies-enabling the system to map complex relationships between data elements in a multi-dimensional space. 1. Vector Embeddings and Content Matching: In a RAG-based LLM, both the student's interaction history (e.g., previous probe results, learning gaps) and the available educational resources (e.g., supplemental content, instructional strategies) are represented as high-dimensional vectors. Each vector captures the semantic meaning of the content, allowing the system to compare student-specific needs with a corpus of teaching strategies or materials. The HNSW algorithm is particularly useful in this context because it enables fast and scalable nearest-neighbor search in this vector space. When the ChatBot needs to retrieve personalized teaching strategies or feedback for an instructor, the system uses HNSW to identify the most relevant vectors (content) by computing the “distance” between the student's current learning context and the available strategies or resources in the knowledge base. Vectors that are semantically closest to the student's current needs are prioritized. 2. Efficient Retrieval of Relevant Teaching Strategies: The HNSW algorithm builds a layered graph structure where vectors representing similar content are connected. This graph is hierarchical, meaning that the algorithm can quickly navigate through higher levels of the graph to find clusters of similar strategies before diving into lower levels for more fine-grained retrieval. As a result, the RAG-based system can rapidly identify the most appropriate teaching strategies without needing to exhaustively search through the entire dataset, even in large knowledge bases. For instance, if a student consistently struggles with vocabulary related to abstract mathematical concepts, the RAG-based LLM—through vector indexing—can retrieve strategies that other students in similar learning contexts have benefited from. These strategies might include re-teaching methods, multimedia resources, or alternative approaches to explaining complex terms. The system's ability to efficiently identify and suggest these strategies in real-time is a key differentiator from traditional systems that rely on static or pre-determined recommendations. 3. Personalized Instructional Recommendations: Once the HNSW algorithm retrieves the nearest-neighbor vectors—those that represent teaching strategies most aligned with the student's learning needs—the RAG-based system uses this information to generate personalized recommendations for instructors. These recommendations are contextually appropriate because they are drawn from a dynamically updated and highly relevant set of instructional strategies. For example, the system might suggest a tailored re-teaching strategy that emphasizes visual learning tools if it detects that the student has had difficulty with text-based vocabulary instruction. By using vector embeddings and the HNSW algorithm to efficiently index and retrieve content, the RAG-based LLM provides a highly effective method of recommending real-time, context-specific teaching strategies. This system enhances the instructional decision-making process by ensuring that educators receive targeted recommendations that are closely aligned with the student's immediate learning needs. This collaborative interaction between the ChatBot and the instructor transforms the traditional role of assessments, turning them into a proactive tool for continuous curriculum improvement and personalized instruction. By effectively utilizing vocabulary matching within this advanced framework, the system 100 offers a powerful and efficient means of tracking and enhancing content mastery across a wide range of educational settings.

The system 100 is equipped with a dynamic, metadata-driven taxonomy that fundamentally redefines how educational content is organized, managed, and delivered. The term “metadata-driven” refers to the system's ability to use structured data about the educational content—such as course objectives, subject areas, grade levels, and learning outcomes—to dynamically organize and adapt the taxonomy in real-time. Each piece of content, whether it's vocabulary, supplemental resources, or course material, is tagged with descriptive metadata that categorizes it according to various educational parameters. This metadata enables the system to intelligently align educational content with the appropriate curriculum structure. For instance, when a course is created or modified, the metadata associated with each unit (e.g., subject, grade level, or specific learning goals) automatically updates the taxonomy, ensuring that the system reflects the current organizational framework. This allows the taxonomy to evolve in real-time without manual intervention, providing unparalleled flexibility to support virtually any educational content organization, from simple classroom structures to complex institutional hierarchies. The dynamic nature of this metadata-driven taxonomy allows seamless integration into any curriculum structure, whether it's a K-12 school district with varying grade levels and subjects or a large university with diverse academic programs spanning multiple disciplines.

What sets this system apart is its ability to align itself with the specific educational objectives and teaching styles of each institution. The metadata-driven approach enables educators to customize the taxonomy according to their unique curricular needs, whether that involves aligning vocabulary terms with state educational standards, tailoring assessments to specific course content, or adapting to evolving educational goals. For instance, in a School of Nursing, the taxonomy can be specifically configured to reflect the hierarchy of medical courses, clinical training modules, and specialized vocabulary that aligns with the latest healthcare protocols. This ensures that the assessments and instructional content are not only relevant but also directly applicable to the students' future professional environments.

Furthermore, the dynamic taxonomy is inherently scalable, allowing it to be applied across a wide range of educational settings and grade levels, from elementary education to advanced post-secondary programs. This scalability is a significant departure from traditional systems, which often require separate tools or configurations for different educational contexts. In contrast, the system 100 provides a unified framework that can be easily expanded or reconfigured as educational needs change, such as when new courses are introduced or when curriculum standards are updated.

Another key advantage of this approach is its ability to support various teaching styles, from traditional lecture-based methods to more modern, interactive, or flipped classroom models. The system's taxonomy can be tailored to reflect the specific pedagogical approach of an educator, ensuring that the vocabulary assessments and instructional content are delivered in a way that complements the teaching style and enhances student engagement. This adaptability makes the system 100 an invaluable tool for educators who are looking to personalize learning experiences and maximize educational outcomes.

By integrating this dynamic, metadata-driven taxonomy, the system 100 not only enhances its applicability across diverse educational settings but also introduces a level of customization and adaptability that is unmatched in existing educational technologies. This capability ensures that the system remains relevant and effective, regardless of the educational context, and provides a robust platform for continuous improvement and innovation in teaching and learning.

The system 100 extends the application of vocabulary matching as a powerful and versatile form of curriculum-based measurement, uniquely capable of being integrated into virtually any course content across all educational levels. This adaptability allows for a consistent model of progress monitoring that transcends traditional subject boundaries, making it applicable to a vast array of educational content areas. Whether the subject is reading, mathematics, science, or social studies at the K-12 level, or specialized fields of study at the post-secondary level such as accounting, biology, business, computing, criminal justice, education, engineering, or health sciences, the system 100 provides a robust framework for assessing and tracking student progress.

The core innovation lies in the system's ability to universally apply the same vocabulary matching methodology across these diverse subject areas. Nearly every course, regardless of its focus, relies on a specific set of essential vocabulary that is critical for understanding the underlying content. The system 100 leverages this commonality by using vocabulary as a gateway to assess broader content mastery. For example, in a K-12 setting, the system can monitor a student's understanding of fundamental terms in subjects like algebra or chemistry, providing insights into their overall comprehension and readiness to advance. In a university context, the same methodology can be applied to track a student's grasp of complex concepts in fields such as molecular biology or corporate finance, ensuring that they are building the necessary foundational knowledge to succeed in their academic and professional pursuits.

What makes this approach particularly effective is its seamless integration with the system's dynamic taxonomy, which customizes the vocabulary matching process to align with the specific educational objectives of each course. This means that the vocabulary assessments are not generic but are tailored to reflect the precise terminology and concepts that are central to the course content. For instance, in a course on criminal justice, the system can focus on legal terminology and case law vocabulary, while in an engineering course, it might assess the student's understanding of technical terms related to mechanical systems or materials science. This targeted approach ensures that the assessments are directly relevant to the students' learning experiences, making the data generated by the system highly actionable for educators.

Furthermore, the system's ability to scale across such a wide range of subjects and educational levels is a significant departure from traditional assessment tools, which are often limited in scope and require different methodologies for different content areas. By providing a unified, vocabulary-based model for progress monitoring, the system 100 not only simplifies the assessment process but also ensures consistency in how student progress is tracked and evaluated. This consistency is crucial for educators who need reliable data to make informed decisions about curriculum development, instructional strategies, and student support.

In summary, the system 100's use of vocabulary matching as a curriculum-based measurement is a transformative approach that can be universally applied across nearly every educational content area and level. This capability makes the system an invaluable tool for educators seeking to enhance student learning outcomes through continuous, data-driven assessment and intervention.

The probes within the system 100 are intelligently and randomly generated from a curated list of essential vocabulary specific to the given course. The term “curated” refers to the process by which the system's vocabulary list is assembled and refined based on input from educators and the system's dynamic, metadata-driven taxonomy. Initially, educators define the key concepts and terminology essential for mastering the course material, tagging each vocabulary term with metadata that aligns it to specific learning objectives, grade levels, and subject areas. The system then organizes and categorizes these terms according to the curriculum structure, ensuring that the vocabulary list is comprehensive and relevant to the course's educational goals. Additionally, the system may incorporate supplemental vocabulary, derived from resources loaded via the RAG LLM Content Loading 2600 module, which is automatically tagged and aligned with the existing taxonomy. This ensures that the curated list reflects both the core course material and any supplementary content. As a result, each probe generated from this curated vocabulary list is representative of the critical concepts students need to master throughout the course. The initial probes, administered early in the course, serve to establish a baseline of each student's knowledge, providing a clear starting point against which future progress can be measured. As the course progresses, subsequent probes are regularly administered, allowing the system to track the student's growth rate as they engage with the course content.

What distinguishes the system 100 is its ability to identify struggling students early in the course through this continuous assessment model. By regularly analyzing the results of these vocabulary probes, the system can detect when a student is deviating from the expected growth trajectory, signaling potential areas of difficulty before they become critical. This early identification is crucial, as it enables instructors to intervene with targeted supplemental instruction precisely when it is most needed, rather than waiting until a student has fallen significantly behind.

Integral to this process is the integration of the Retrieval Augmented Generation (RAG) ChatBot, which plays a pivotal role in both monitoring and supporting student progress. After each probe is completed, the ChatBot analyzes the results in real-time, comparing the student's performance against the established baseline and expected growth rate. If the ChatBot detects that a student is not progressing as expected, it proactively engages with both the student and the instructor. For the student, the ChatBot may offer additional practice exercises, provide explanations for missed vocabulary terms, or suggest specific study strategies to help them improve. For the instructor, the ChatBot acts as a collaborative partner, offering insights into the student's performance, recommending instructional adjustments, and suggesting specific areas where the student might benefit from further support.

This ongoing, dynamic interaction between the student, instructor, and ChatBot ensures that progress is not only tracked but actively managed throughout the course. The instructor can easily monitor each student's weekly progress, assess the effectiveness of any instructional changes made, and make data-driven decisions to optimize learning outcomes. The ChatBot's ability to provide real-time feedback and recommendations further enhances this process, ensuring that both students and instructors are continuously supported with the most relevant and actionable information.

By combining the random generation of vocabulary probes with the real-time analysis and feedback provided by the RAG ChatBot, the system 100 offers a powerful, proactive approach to student assessment and support. The vocabulary words included in each probe are randomly selected from a curated list associated with the course's core objectives. This random assignment ensures that probes include vocabulary terms that have already been covered, verifying retention of learning over time, as well as words that have not yet been introduced, providing a measure of the student's potential growth as the course progresses. This approach allows educators to not only assess current knowledge but also track how well students are adapting to and absorbing new content over time. By evaluating both retention and readiness for new vocabulary, the system offers a comprehensive understanding of a student's learning trajectory throughout the course. The randomization of the probes ensures an unbiased, holistic assessment, helping to prevent any predictability in the evaluation process. Coupled with real-time feedback from the RAG ChatBot, instructors can make timely instructional adjustments to support both current understanding and future growth, ultimately improving educational outcomes.

Unlike traditional progress monitoring applications that typically concentrate on assessing specific content mastery through benchmark or summative assessments administered at the end of a unit, semester, or academic year, the system 100 introduces a fundamentally different approach. Designed for continuous deployment, this system delivers weekly assessments starting from the very beginning of the course and continuing throughout its duration. This regular cadence of assessments provides educators with an immediate and ongoing understanding of which students may require supplemental instruction, allowing for timely and targeted interventions.

The system's weekly vocabulary probes not only evaluate new content but are also strategically designed to assess students' retention and maintenance of previously learned material. By randomly distributing vocabulary words across these probes, the system ensures that students regularly revisit and reinforce their understanding of essential terms. This method allows educators to gauge not only the acquisition of new knowledge but also the durability of that knowledge over time, which is critical for ensuring long-term academic success.

The continuous nature of these assessments enables the system 100 to track subtle shifts in student performance that might otherwise go unnoticed in more sporadic assessment models. For instance, if a student initially demonstrates mastery of a particular set of vocabulary terms but begins to struggle with them later in the course, the system can quickly flag this issue. The Retrieval Augmented Generation (RAG) ChatBot then steps in to provide immediate support, engaging the student with targeted review exercises or clarifications tailored to their specific needs. Simultaneously, the ChatBot collaborates with the instructor, offering insights into the student's retention patterns and suggesting strategies to reinforce the material in future lessons.

This combination of frequent, randomized assessments and real-time, adaptive feedback creates a comprehensive picture of each student's learning journey. It allows educators to understand not only how well students are grasping new content but also how effectively they are retaining and integrating that knowledge over time. By continually assessing and reinforcing vocabulary knowledge, the system 100 ensures that students build a strong, lasting foundation that supports their ongoing academic development.

The shift from traditional, end-point assessments to a model of continuous, integrated evaluation actively supports both the acquisition and retention of knowledge. This approach provides a more nuanced and actionable understanding of student progress, enabling educators to deliver more personalized and effective instruction throughout the course.

As this is a single model for student progress measurement and tracking, the system 100 simplifies the implementation, training, and understandability for all (educators, students, parents). As a part of Dictionary Class Assignment 1600, the instructor for a given class Instructor Class Assignment 1200 can choose the starting and ending dates for the class and how frequently to give assessments (probes), either weekly, every two weeks, or every four weeks. Based on these choices, the system 100 automatically calculates the number of probes to assign in Dictionary Class Assignment 1600.

Based on a learner's scores of the first, say, three probes, the system 100 automatically calculates the mean of the scores as the baseline, and calculates a target growth rate as a configurable percentage increase across the range of remaining probes, and plots a growth target line for the learner and the instructor to monitor progress on both Teacher Class Progress Page 1800 and Student Class Page 2400.

On Teacher Landing Page 1700, if an instructor clicks on a class tile, they are directed to the corresponding Teacher Class Progress Page 1800. On Teacher Class Probes Page 1900, if a probe has already been administered, the page will display a checkmark next to the probe. Also on this page, if another probe is available, and no other probe is active, the next available probe will display an “Enable Probe” button so the instructor can activate the probe for the learners. If the instructor clicks on the “Enable Probe” button, they are directed to Teacher Class Probe Enable 2000. Enabling a probe calls a procedure to enable probe for the learners.

On Student Probe Page 2500, if a learner clicks on a word that has not been associated with a definition yet, then clicks on a definition, the system 100 associates the word with the definition. If the learner clicks on a word that has already been associated with a definition, then the system 100 displays a dialog box asking the learner if they want to un-assign the word. If the learner clicks yes on the dialog box, the word is unassigned from the definition and can be selected again to be assigned to another definition.

While making/coding the system 100, an operator may code an application that utilizes a database to store the metadata and the administrator, instructor and learner interactions that occur in each of the steps defined herein, and code screens that provides a system administrator with the ability to complete the steps listed herein from Tenant Configuration 200 through Dictionary Class Assignment 1600 in sequence. Additionally, code screens may be made that provide an instructor with the ability to access and interact with the steps listed herein from Teacher Landing Page 1700 through Teacher Class Vocabulary Page 2200. Additionally, code screens may be made that provide a learner with the ability to access and interact with the steps listed herein from Student Landing Page 2300 through Student Probe Page 2500. The operator may further reference the step sequences, drawings and logic listed herein to implement the interactions and their desired effects.

To enhance the functionality and adaptability of the system 100, incorporating support for language translation across multiple languages would significantly broaden its applicability in diverse educational environments. This capability would allow the system to deliver personalized, curriculum-aligned assessments and instructional content to students in their native languages, thereby improving accessibility and engagement. The RAG ChatBot would play a crucial role in this multilingual environment by not only translating vocabulary terms and instructional content but also by adapting its conversational interactions to the specific linguistic and cultural context of the learner. This ensures that the feedback and support provided by the ChatBot are both accurate and culturally relevant, which is essential for maintaining effective communication and enhancing the learning experience across different regions.

In addition to multilingual support, the system's architecture is designed to be highly modular, with backend system components that can be utilized individually through API calls. This modularity allows educational institutions and third-party providers to selectively integrate specific features of the system into their existing platforms. For example, a learning management system (LMS) provider could choose to embed the vocabulary assessment module directly into their course management interface, leveraging the system's robust progress monitoring capabilities without needing to overhaul their entire infrastructure. The RAG ChatBot's APIs could also be exposed, enabling third-party applications to utilize its advanced features, such as real-time performance analysis and personalized instructional recommendations, within their own environments.

Moreover, the backend components of the system 100 can be offered as RESTful APIs, allowing seamless integration with other digital curriculum and content providers. These providers could embed the system's progress monitoring tools directly into their existing products, creating custom user interfaces that align with their branding while still benefiting from the system's foundational components. The RAG ChatBot, in particular, offers unique value in this context by providing third-party applications with an intelligent, adaptive tool that can analyze student data, offer personalized feedback, and suggest targeted interventions-all in real-time. This integration would not only enhance the capabilities of third-party educational tools but also ensure that students and educators have access to consistent, high-quality support regardless of the platform they are using.

By supporting language translation, offering modular components through APIs, and enabling third-party integrations via RESTful APIs, the system 100 provides a flexible and scalable solution that can be tailored to meet the diverse needs of educational institutions and digital curriculum providers. The RAG ChatBot's ability to adapt to different languages, integrate with various platforms, and provide personalized, data-driven insights further enhances the system's value, making it a versatile and indispensable tool in modern education.

Existing online assessment systems predominantly target content mastery within specific subjects or grade levels, often relying on isolated, point-in-time evaluations. These assessments typically focus on whether students have grasped certain topics at the end of a unit or term, resulting in a fragmented approach that requires educational institutions to invest in multiple vendor solutions to cover the full spectrum of their curricular needs. This fragmentation not only increases costs but also leads to a disjointed and incomplete understanding of student progress, as different tools may not integrate seamlessly, leaving gaps in the data that educators rely on to make informed decisions.

In stark contrast, the system 100 introduces a fundamentally different approach by offering a universal framework for continuous assessment and progress monitoring that spans virtually all subjects and grade levels, from K-12 to higher education. This framework does not merely assess content mastery at isolated points; instead, it employs brief, frequent curriculum-based measurements focused on the essential vocabulary that students must master throughout a course. By leveraging vocabulary matching as a core assessment tool, the system 100 provides a consistent and scalable solution that delivers real-time insights into student growth and the maintenance of skills over time.

One of the most significant differentiators of the system 100 is its ability to unify the assessment process across diverse educational contexts. Rather than requiring separate tools for different subjects or grade levels, this system offers a single, cohesive solution that adapts to the specific needs of any educational institution. This adaptability ensures that educators can monitor student progress continuously, regardless of the subject being taught, and provides a holistic view of student development that is both comprehensive and actionable.

The system's weekly assessments are another key differentiator, designed to be brief (between one and ten minutes, in some embodiments) yet powerful in their ability to track and graph student performance automatically. These assessments are not only efficient, minimizing disruption to instructional time, but also highly effective in identifying students who may be falling behind. The Retrieval Augmented Generation (RAG) ChatBot amplifies this capability by analyzing the assessment data in real-time, offering immediate insights to instructors, and suggesting targeted interventions that can be implemented before small issues become significant barriers to student success.

By delivering continuous, vocabulary-based assessments that are seamlessly integrated into the broader educational framework, the system 100 eliminates the need for multiple, disparate tools and provides educators with a unified, data-driven approach to monitoring and supporting student progress. This holistic, consistent solution represents a significant advancement over traditional assessment methods, offering a more complete and integrated view of student learning that empowers educators to act swiftly and effectively to enhance educational outcomes and students content mastery. It is understood that the term “content mastery” is well understood educational contexts, particularly in curriculum design, instructional strategies, and assessment development, to denote a student's achievement of the expected learning outcomes. Educators, curriculum developers, and education administrators regularly use this term when discussing standards-based education, where students are expected to demonstrate mastery of specific content before moving on to the next level of learning.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for calving out operations of the present invention maybe assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The claimed invention is:

1. A system for employing taxonomy-based classifications to generate vocabulary matching assessments for a student in a course curriculum, the system comprising:
a systemic database that receives educational content data and institutional organization data from one or more sources of educational information;
a taxonomy module that processes the institutional organization data to generate taxonomy-based classifications of the institutional organization data, wherein at least one taxonomy-based classification is a course having the course curriculum;
a content loading module configured to associate vocabulary terms embedded in the educational content data with the course based on, for each associated vocabulary term, metadata derived from a relationship between the associated vocabulary term and the taxonomy-based classifications; and
a probe module configured to administer a plurality of periodic vocabulary matching assessments to the student, wherein each vocabulary matching assessment includes one or more associated vocabulary terms.

2. The system of claim 1, wherein the probe module is further configured to establish, from previously administered vocabulary matching assessments, a baseline and a trendline based on each of the previously administered vocabulary matching assessments, wherein the trendline is updated in real-time.

3. The system of claim 2, further comprising a retrieval augmented generation chatbot (RAGC) module, wherein the RAGC module incorporates a customizable corpus of supplemental instructional content, and wherein the RAGC module is configured to provide conversational feedback to the student, wherein the conversational feedback is based on the customizable corpus of supplemental instructional content and the trendline.

4. The system of claim 3, wherein the RAGC module is configured to provide conversational feedback to an instructor of the student, wherein the conversational feedback is based on the customizable corpus of supplemental instructional content and the trendline.

5. The system of claim 4, wherein the RAGC module is further comprises a hierarchical navigable functionality, wherein the customizable corpus of supplemental instructional content comprises a corpus of instructional strategies, and wherein the hierarchical navigable functionality identifies at least one of the instructional strategies of the corpus of instructional strategies so that the conversational feedback comprises identified instructional strategies.

6. The system of claim 5, wherein the hierarchical navigable functionality builds a layered graph structure where vectors connect strategic content of each of the instructional strategies and trendline content of the trendline, wherein trendline content is based on at least one associated vocabulary term of at least one previously administered vocabulary matching assessments.

7. The system of claim 2, further comprising an instructor insight module configured to generate a report comprising the baseline and the trendline.

8. The system of claim 1, wherein the relationship between the associated vocabulary term and the taxonomy-based classifications is based on vector indexing.

9. The system of claim 1, wherein the institutional organization data comprises a plurality of educational settings, a plurality of subjects, a plurality of courses of which the course is one, and one or more course levels for each course of the plurality of courses, wherein the taxonomy module defines a matrix of nested hierarchies from said pluralities of educational settings, subjects, courses, and course levels.

10. The system of claim 9, wherein the plurality of educational settings comprises educational levels from kindergarten to post-secondary education, and wherein each said educational level defines a nested hierarchy of at least one subject, course and course level, respectively.
